(19) United States
(12) Patent Application Publication
(10) Pub. No.: US 2026/0228570 A1
(43) Pub. Date: Aug. 6, 2026

(54) MULTIPLE COMPUTING ZONES SYSTEM AND METHOD FOR TRAINING AND DEPLOYING AN ARTIFICIAL INTELLIGENCE MODEL

(71) Applicant: The Toronto-Dominion Bank, Toronto (CA)

(72) Inventors: Sherman CHUNG, Toronto (CA); Zhaonan QIN, Toronto (CA); Kien Nghe LY, Toronto (CA); Upal HOSSAIN, Toronto (CA)

(21) Appl. No.: 19/045,931

(22) Filed: Feb. 5, 2025

(51) Int. Cl. G06N 5/02; G06F 21/62

(52) U.S. Cl. CPC G06N 5/027; G06F 21/6218

(57) ABSTRACT

Systems and methods are provided for deploying of an AI model for production. A staging zone receives a trained AI model from a segment analytics zone, and tests the trained AI model. A central model registry receives and stores model artifacts outputted from the trained AI model operating in the segment analytics zone, and model artifacts outputted from the trained AI model operating in the staging zone. A model validation (MV) analytics zone receives from the central model registry, and analyzes the model artifacts outputted from the trained AI model operating in the segment analytics zone, and the model artifacts outputted from the trained AI model operating in the staging zone. When the MV analytics zone determines that a deployment condition is satisfied, the trained AI model is deployed to a production zone.

### TECHNICAL FIELD

The disclosed exemplary embodiments relate to a multiple computing zone system and method for generating and deploying an artificial intelligence (AI) model.

### BACKGROUND

Data Operations (DataOps) is an integrated computing process for delivering data analytic solutions that uses automation, testing, orchestration, collaborative development, and continuous monitoring to continuously accelerate output for developing software.

In existing DataOps approaches for software development, the process includes development, systems integration testing, acceptance testing, and production. Some existing DataOps processes and computing environments may be suitable for high-risk extract, transform and load (ETL) processes. However, in some cases, these processes and computing environments are computationally slow and not well suited to artificial intelligence (AI) and machine learning (ML) computational architectures.

### SUMMARY

The following summary is intended to introduce the reader to various aspects of the detailed description, but not to define or delimit any invention.

In at least one broad aspect, a cloud computing system is provided, comprising: a segment analytics zone comprising a segment analytics virtual computing machine, wherein the segment analytics zone is configured to train and output a trained artificial intelligence (AI) model; a staging zone comprising a staging virtual computing machine, and wherein the staging zone is further configured to receive the trained AI model from the segment analytics zone and test the trained AI model; a production zone comprising a production virtual computing machine; a central model registry configured to receive and store at least model artifacts outputted from the trained AI model operating in the segment analytics zone, and model artifacts outputted from the trained AI model operating in the staging zone; and a model validation (MV) analytics zone comprising a MV analytics virtual computing machine, the MV analytics zone configured to receive from the central model registry, and analyze, at least the model artifacts outputted from the trained AI model operating in the segment analytics zone, and the model artifacts outputted from the trained AI model operating in the staging zone. When the MV analytics zone determines that a deployment condition is satisfied, the MV analytics zone or the staging zone, or both, initiates deployment of the trained AI model from the staging zone to the production zone.

In some cases, the staging zone is configured as a computing framework representative of a production framework, and the production zone configured as the production framework. In some cases, after the trained AI model has been deployed from the staging zone to the production zone, the production zone is configured to automatically operate the trained AI model in the production framework.

In some cases, the deployment of the trained AI model to the production zone comprises automatically transferring the model artifacts outputted from the trained AI model operating in the staging zone, which are stored in the central model registry, to the trained AI model in the production zone.

In some cases, the deployment condition comprises the trained AI model in the staging zone generating a set of staging results that are within an expected range as a set of training results generated by the trained AI model in the segment analytics zone.

In some cases, when the MV analytics zone determines that the deployment condition is unmet, analytics data from the MV analytics zone is provided to the segment analytics zone to train and output a subsequent AI model; the subsequent AI model is tested in the staging zone; and, when the MV analytics zone determines the deployment condition is satisfied for the subsequent AI model, the MV analytics zone or the staging zone, or both, initiates deployment of the subsequent AI model from the staging zone to the production zone.

In some cases, the cloud computing system further comprises a data repository, which comprises production data and training data, the training data comprising masked data derived from the production data. In some cases, the trained AI model in the segment analytics zone is trained using the training data obtained from the data repository. In some cases, the trained AI model in the staging zone is tested using the production data.

In some cases, the segment analytics zone comprises a first set of data security conditions; the staging zone comprises a second set of data security conditions that is more restrictive than the first set of data security conditions; and the production zone comprises a third set of data security conditions that is more restrictive than the second set of data security conditions.

In some cases, the first set of data security conditions comprises a first number of data access accounts permitted to access the segment analytics zone; wherein the second set of data security conditions comprises a second number of data access accounts permitted to access the staging zone, the second number less than the first number; and wherein the third set of data security conditions comprises a third number of data access accounts permitted to access the production zone, the third number less than the second number.

In some cases, the cloud computing system comprises a delivery pipeline that connects at least the segment analytics zone, the staging zone, and the production zone. In some cases, the trained AI model in the segment analytics zone is deployed to the staging zone via the delivery pipeline, and the trained AI model in the staging zone is deployed to the production zone via the delivery pipeline.

In some cases, the cloud computing system comprises a data pipeline that connects the central model registry to the MV analytics zone. In some cases, the MV analytics zone is configured to only read data from the central model registry via the data pipeline.

In at least another broad aspect, a method for deploying an artificial intelligence (AI) model is provided. The method is executed in a cloud computing system comprising a segment analytics zone comprising a segment analytics virtual computing machine, a staging zone comprising a staging virtual computing machine, a production zone comprising a production virtual computing machine, a central model registry, and a model validation (MV) analytics zone comprising a MV analytics virtual computing machine. In some cases, the method comprises: the segment analytics zone training and outputting a trained AI model; the staging zone receiving the trained AI model from the segment analytics zone and testing the trained AI model; the central model registry receiving and storing at least model artifacts outputted from the trained AI model operating in the segment analytics zone, and model artifacts outputted from the trained AI model operating in the staging zone; the MV analytics zone receiving from the central model registry, and analyzing, at least the model artifacts outputted from the trained AI model operating in the segment analytics zone, and the model artifacts outputted from the trained AI model operating in the staging zone; and, when the MV analytics zone determines that a deployment condition is satisfied, the MV analytics zone or the staging zone, or both, initiating deployment of the trained AI model from the staging zone to the production zone.

In some cases, the staging zone is configured as a computing framework representative of a production framework, and the production zone configured as the production framework. In some cases, the method further comprises after the trained AI model has been deployed from the staging zone to the production zone, the production zone automatically operates the trained AI model in the production framework.

In some cases, the deployment of the trained AI model to the production zone comprises automatically transferring the model artifacts outputted from the trained AI model operating in the staging zone, which are stored in the central model registry, to the trained AI model in the production zone.

In some cases, the deployment condition comprises the trained AI model in the staging zone generating a set of staging results that are within an expected range as a set of training results generated by the trained AI model in the segment analytics zone.

In some cases, the method further comprises: when the MV analytics zone determines that the deployment condition is unmet, analytics data from the MV analytics zone is provided to the segment analytics zone to train and output a subsequent AI model; the subsequent AI model is tested in the staging zone; and, when the MV analytics zone determines the deployment condition is satisfied for the subsequent AI model, the MV analytics zone or the staging zone, or both, initiating deployment of the subsequent AI model from the staging zone to the production zone.

In some cases, the cloud computing system further comprises a data repository, which comprises production data and training data, the training data comprising masked data derived from the production data; wherein the trained AI model in the segment analytics zone is trained using the training data obtained from the data repository. In some cases, the trained AI model in the staging zone is tested using the production data.

In some cases, the segment analytics zone comprises a first set of data security conditions; the staging zone comprises a second set of data security conditions that is more restrictive than the first set of data security conditions; and the production zone comprises a third set of data security conditions that is more restrictive than the second set of data security conditions.

In some cases, the first set of data security conditions comprises a first number of data access accounts permitted to access the segment analytics zone; wherein the second set of data security conditions comprises a second number of data access accounts permitted to access the staging zone, the second number less than the first number; and wherein the third set of data security conditions comprises a third number of data access accounts permitted to access the production zone, the third number less than the second number.

In some cases, the cloud computing system further comprises a delivery pipeline that connects at least the segment analytics zone, the staging zone, and the production zone. In some cases, the trained AI model in the segment analytics zone is deployed to the staging zone via the delivery pipeline, and the trained AI model in the staging zone is deployed to the production zone via the delivery pipeline.

In some cases, the cloud computing system further comprises a data pipeline that connects the central model registry to the MV analytics zone, wherein the MV analytics zone is configured to only read data from the central model registry via the data pipeline.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud-based computing cluster of FIG. 1A, including a multiple computing zone system configured to unify a development and production computations for an AI model, in accordance with at least some embodiments;

FIG. 2 is a block diagram of a computer in accordance with at least some embodiments;

FIG. 3 is a schematic block diagram of the computing zones in FIG. 1B showing example the flow of example data components, in accordance with at least some embodiments;

FIG. 4 is a schematic block diagram of computing zones architecture configured with different subset curated zones for staging and corresponding separate model validation analytics zones, in accordance with at least some embodiments;

FIG. 5 is a flowchart diagram of an example method of deploying an AI model, in accordance with at least some embodiments; and

FIG. 6 is a flowchart diagram of an example method of deploying a subsequent AI model, when a first AI model is not validated, in accordance with at least some embodiments.

### DETAILED DESCRIPTION

Existing computing systems for software development, such as SDLC (software development life cycle), occur in curated zones or curated computing environments, which are slow and not well suited to AI and ML computational architectures. There is a lack of communication and access to training data and intermediate data specific to AI and ML models.

In some cases, existing computing systems do not use production data for training and testing an AI model, in some cases leading to inaccurately trained and tested AI models. In some other cases, the training data is not representative of the latest production data, in some cases leading to inaccurately trained and tested AI models.

In some cases, a cloud computing system is provided for accelerated software development of AI and ML models. The cloud computing system includes a segment analytics zone, a model validation (MV) analytics zone, a staging zone, and a central model registry. The segment analytics zone is configured to train an AI model. The MV analytics zone is configured to validate the AI model. The staging zone is configured to test an AI model in a computing framework representative of a production framework. The cloud computing system automatically stores model artifacts outputted from the AI model in the segment analytics zone, or the AI model in the staging zone, or a combination thereof, into one or more containers in the central model registry, and facilitates retrieval of the model artifacts from the one or more containers for use in the staging zone or a production zone, or both.

In some cases, the configuration and interaction of the different zones in the cloud computing system accelerates the deployment of an AI model into a production zone. In some cases, the configuration and interaction of the different zones in the cloud computing system is better suited to analytical software that includes data science models, such as AI models and ML models.

In some cases, training data that is representative of recent or most recent production data is used to train an AI model, leading to a more accurate or effective AI model. In some cases, raw production data is used to test an AI model, also leading to a more accurate or effective AI model for deployment in a production environment.

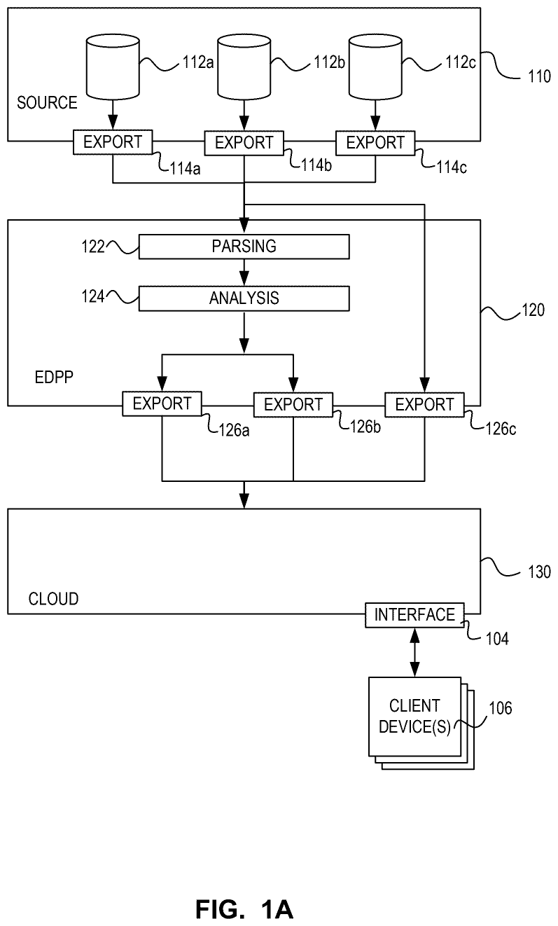

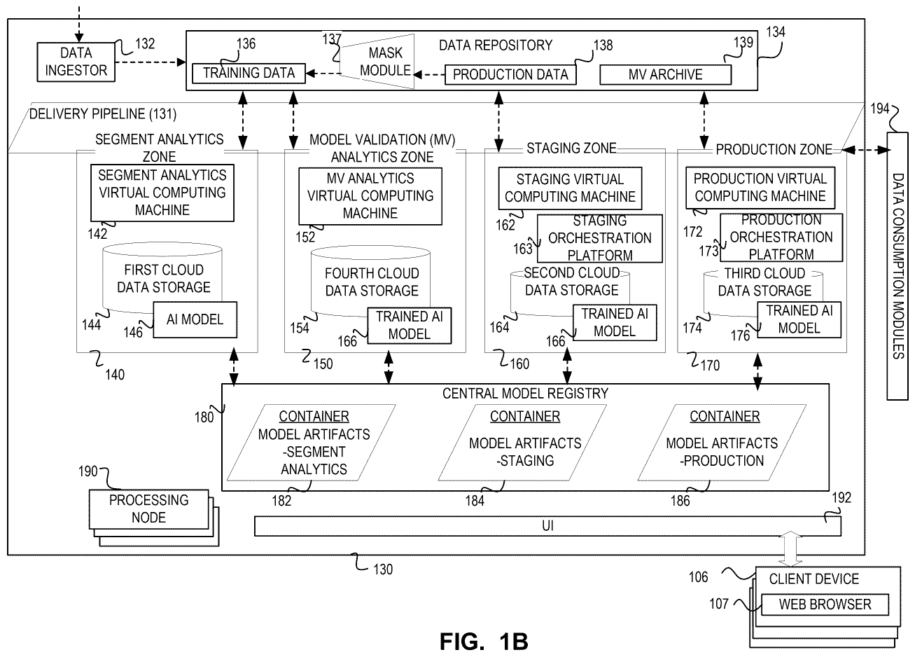

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases, this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 104, which facilitates communicating with one or more client devices 106.

In some environments, the EDPP may be omitted.

Referring now to FIG. 1B, there is illustrated a block diagram of the cloud-based computing cluster 130, showing greater detail of the elements of the cloud-based computing cluster, which may be implemented by processing nodes 190 of the cluster that are operatively coupled.

The components of the cloud-based computing cluster 130 include a data ingestor 132, a data repository 134, a segment analytics zone 140, a MV analytics zone 150, a staging zone 160, a production zone 170, and a central model registry. In some cases, the components further include a delivery pipeline 131 and a user interface 192.

In some cases, production data 138 is received by the data ingestor and stored in the data repository 134. The data repository 134 stores thereon training data. In some cases, the data repository 134 comprises masked data that is derived from the production data 138. In some cases, a mask module 137 processes the production data 138 to generate the training data 136 that includes the masked data. For example, the training data does not include any PII or confidential data, or both. The masked data, for example, masks, removes or obfuscates PII or confidential data, or both.

In some cases, each zone includes a computing resource.

In some cases, each zone in the cloud-based computing cluster refers to a collection of computing infrastructure that includes a virtual computing machine and a cloud data storage. In some cases, the cloud data storage is called a data lake or a data lake zone. In some cases, each zone has a specific function that includes its own consumption pattern of the data within it local cloud data storage.

In some cases, the segment analytics zone 140, the staging zone 160, the production zone 170, and the MV analytics zone 150 are configured to be different stages that collectively train, test, analyze and deploy an AI model for operation in the production zone 170. In some cases, the staging zone and the production zone are each curated zones.

In some cases, the specialization of data and functions for each zone facilitates faster discovery and processing of the data within each respective zone. In some cases, the specialization of data and functions for each zone facilitates more control over each stage of the development and deployment of the AI model, meanwhile without affecting the AI model deployed and operating in the production zone. In some cases, the specialization of data and functions for each zone facilitates better data security and data compliance as appropriate to the functions and/or data in each zone. In some cases, there are additional types of tangible effects to the cloud computing system when training, testing and deployment of an AI model.

In some cases, the segment analytics zone 140 includes a segment analytics virtual computing machine 142 and a first cloud data storage 144, which is accessible by the segment analytics virtual computing machine 142. In some cases, the staging zone 160 includes a staging virtual computing machine 162 and a second cloud data storage 164, which is accessible by the staging virtual computing machine 162. In some cases, the production zone 170 includes a production virtual computing machine 172 and a third cloud data storage 174, which is accessible by the production virtual computing machine 172.

In some cases, the staging zone 160 also includes a staging orchestration platform 163, and the production zone also includes a production orchestration platform 173. In some cases, an orchestration platform refers a structured platform that automates, coordinates, and manages complex computation tasks and computational workflows.

In some cases, the staging zone 160 is configured as a computing framework representative of a production framework, and the production zone 170 configured as the production framework. In some cases, the staging orchestration platform 163 is configured to be the same or to operate using the same computational tasks and/or computational workflows as the production orchestration framework.

In some cases, the MV analytics zone 150 includes a MV analytics virtual computing machine 152, and a fourth cloud data storage 154 that is accessible by the MV analytics virtual computing machine 152.

In some cases, the central model registry 180 is configured to receive and store at least model artifacts outputted from the trained AI model operating in the segment analytics zone, and model artifacts outputted from the trained AI model operating in the staging zone. In some cases, the central model registry 180 includes a container 182 that stores model artifacts outputted from the AI model 146 during training in the segment analytics zone 140. In some cases, the central model registry 180 includes a container 184 that stores model artifacts outputted from the AI model 166 during testing of a trained AI model operating in the staging zone 160. In some cases, the central model registry 180 includes a container 186 that stores model artifacts outputted from the trained AI model 176 operating in the production zone 170.

In some cases, the AI model 146 in the segment analytics zone 140 is trained using the training data 136 obtained from the data repository 134, which generates the trained AI model 166. In some cases, the trained AI model 166 in the staging zone 160 is tested using the production data 138.

In some cases, the delivery pipeline 131 connects at least the segment analytics zone 140, the staging zone 160, and the production zone 170. In some cases, the trained AI model 146 that is developed or trained in the segment analytics zone 140 is deployed to the staging zone 160 via the delivery pipeline 131. In some cases, the trained AI model 166 in the staging zone 160 is deployed to the production zone 170 via the delivery pipeline 131. In some cases, the deployment is initiated when a deployment condition is satisfied.

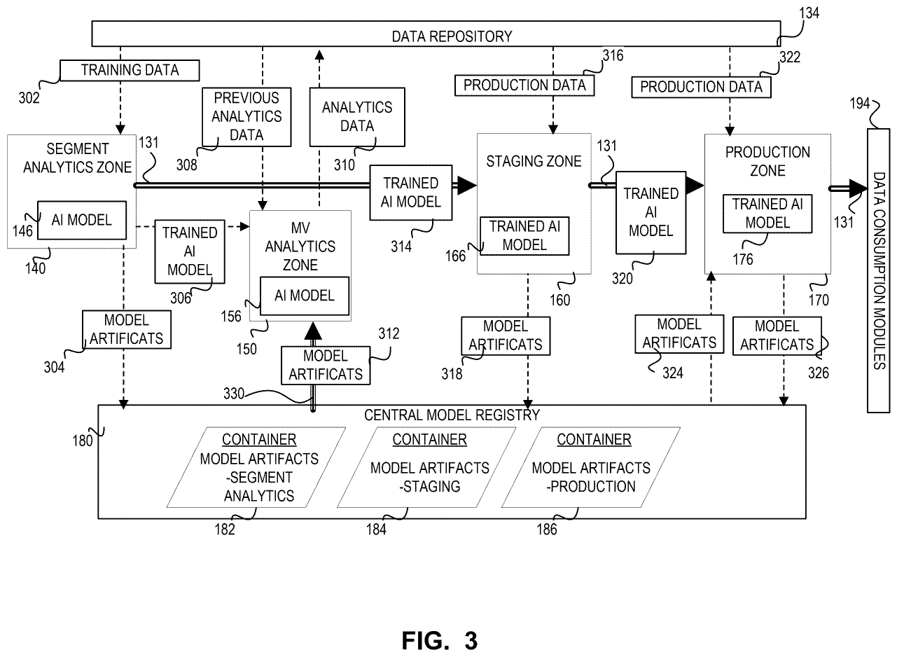

In some cases, as better shown in FIG. 3, a data pipeline 330 connects the central model registry 180 to the MV analytics zone 150. In some cases, the MV analytics zone 150 is configured to only read data from the central model registry 180 via the data pipeline 330.

In some cases, the model artifacts include one or more outputs generated by the training, staging, or production processes, or a combination thereof. In some cases, the model artifacts include a fully trained model, a model checkpoint, or a file created during training. In some cases, the model artifacts include datasets, labels and annotations, feature sets, data processing source code, logs, metadata such as parameters or hyperparameters, model processing source code, environmental dependencies, libraries, or performance metrics, or a combination thereof.

Turning back to FIG. 1B, in some cases, the trained AI model 176 in the production zone 170 processed production data 138 from the data repository and outputs results to one or more data consumption modules 194. In some cases, the one or more data consumption modules include a table-based platform, an application programming interface (API) app, an event grid, a logic app, or a downstream application, or a combination thereof.

In some cases, the segment analytics zone comprises a first set of data security conditions, the staging zone comprises a second set of data security conditions that is more restrictive than the first set of data security conditions, and the production zone comprises a third set of data security conditions that is more restrictive than the second set of data security conditions. In some cases, the first set of data security conditions comprises a first number of data access accounts permitted to access the segment analytics zone. In some cases, the second set of data security conditions comprises a second number of data access accounts permitted to access the staging zone, the second number less than the first number. In some cases, the third set of data security conditions comprises a third number of data access accounts permitted to access the production zone, the third number less than the second number.

In some cases, the data security conditions include guardrails. In some cases, guardrails are security controls. In some cases, guardrails include controls for restricting internet gateways, controls for restricting network address translation (NAT) gateways, or policies regarding ingress and egress paths to the given zones, or a combination thereof.

In some cases, data accounts are interactive via a user interface (UI) 192, and accessible by a web browser 107 on a client device 106. A user can use their data account to access the segment analytics zone, or the model validation zone, or the staging zone, or the production zone, depending on the access permission of their data account.

In some cases, a virtual desktop infrastructure (VDI) is used to create and facilitate custom data access patterns between zones. For example, users with different access permissions can access a segment analytics zone, or a model validation analytics zone, or a staging zone, or a production zone, or a combination thereof, according to an access pattern. In some cases, hundreds of users can access the segment analytics zone and/or the model validation analytics zone (which in some cases uses masked data derived from the production data), and a smaller group of users (e.g., 10 users) can access the staging zone (which in some cases uses production data), in order to safeguard the production data.

In some cases, the staging zone 160 tests an AI model using production data, which is a safeguarded environment that mimics the production environment. In some cases, when the analytics data from the MV analytics zone 150 is used to determine that a deployment condition is met, then the trained AI model is deployed from the staging zone into the production zone.

In some cases, the analytics data includes performance data, data leakage scoring and/or statistics, bias scoring and/or statistics, or other testing data, or a combination thereof. In some cases, the analytics data is stored in the MV archive 139.

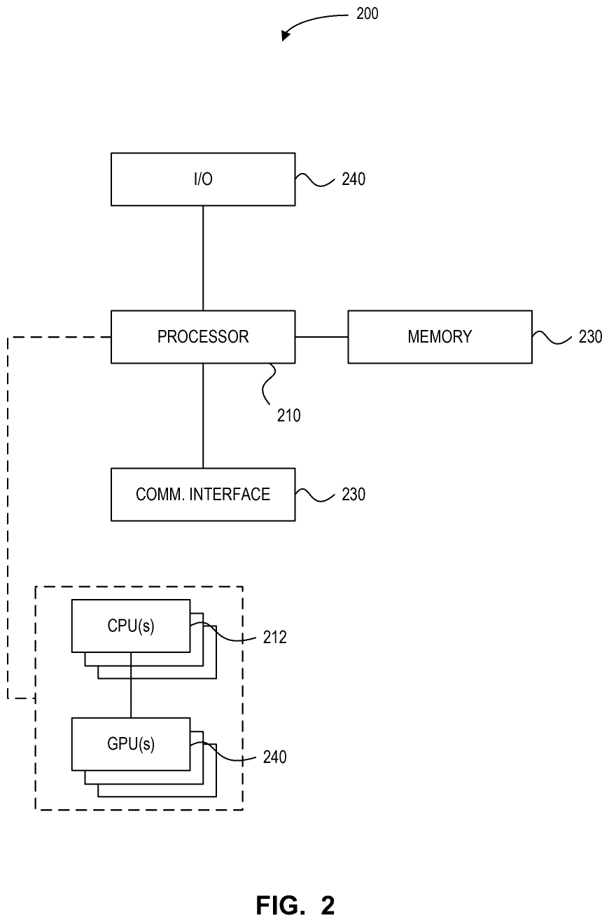

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 190 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data-e.g., within a database-along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, an AI model executes neural network computations on CPU and GPU hardware, such as the system of CPUs 212 and GPUs 214.

Referring now to FIG. 3, production data is ingested into the data repository 134, such as via batch ingestion or continuous real-time ingestion. The production data is used to generate training data. In the action 302, training data is transmitted from the data repository 134 to the segment analytics zone 140 to train the AI model 146. In some cases, this training generates model artifacts, and in action 304, the model artifacts from the segment analytics zone 140 are transmitted to the container 182 for storage in the central model registry 180.

In some cases, in the action 314, the trained AI model is transmitted from the segment analytics zone 140 to the staging zone 160, via the delivery pipeline 131. The trained AI model in the staging zone 160 is tested using production data. In particular, in the action 316, the production data is transmitted from the data repository 134 to the staging zone 160. In some cases, this testing generates model artifacts, and in action 318, the model artifacts from the staging zone 160 are transmitted to the container 184 for storage in the central model registry 180.

In some cases, in action 306, the trained AI model from the segment analytics zone 140 is transmitted to the MV analytics zone 150. In some cases, in action 312, model artifacts from the central model registry 180 are transmitted to the MV analytics zone 150 for analysis. In some cases, the transmission at action 312 occurs over the data pipeline 330. In some cases, the MV analytics zone 150 is configured to receive and analyze at least the model artifacts outputted from the trained AI model operating in the segment analytics zone, and the model artifacts outputted from the trained AI model operating in the staging zone. In some cases, in action 310, the analytics data is transmitted to the data repository 134 for storage, such as in the MV archive. In some cases, in action 308, previous analytics data is transmitted from the data repository 134 to the MV analytics zone 150 to execute comparative analysis.

In some cases, when the MV analytics zone 150 determines that a deployment condition is satisfied, the MV analytics zone 150 or the staging zone 160, or both, initiates deployment of the trained AI model from the staging zone to the production zone.

In some cases, in action 320, the trained AI model from the staging zone 160 is transmitted to the production zone 170. In some cases, the action 320, which is also referred to as a deployment of the trained AI model to the production zone, includes or is accompanied by an action 324. The action 324 includes automatically transferring the model artifacts outputted from the trained AI model operating in the staging zone, which are stored in the central model registry 180, to the trained AI model in the production zone 170.

In some cases, the deployment condition comprises the trained AI model in the staging zone 160 generating a set of staging results that are within an expected range as a set of training results generated by the trained AI model in the segment analytics zone 140.

In some cases, in action 322, the live or most recent production data is transmitted from the data repository 134 to the production zone 170 via the delivery pipeline 131. The trained AI model operating in the production zone 170 processes this production data, which generates model artifacts. In some cases, in action 326, the model artifacts outputted by the trained AI model in the production zone is transmitted to the container 186 for storage in the central model registry 180.

In some cases, when the MV analytics zone determines that the deployment condition is unmet, analytics data from the MV analytics zone is provided to the segment analytics zone to train and output a subsequent AI model; the subsequent AI model is tested in the staging zone; and, when the MV analytics zone determines the deployment condition is satisfied for the subsequent AI model, the MV analytics zone or the staging zone, or both, initiates deployment of the subsequent AI model from the staging zone to the production zone.

In some cases, the communication or transmission of data between the data repository 134 and the segment analytics zone 140, the staging zone 160, and the production zone 170 occur via the delivery pipeline 131.

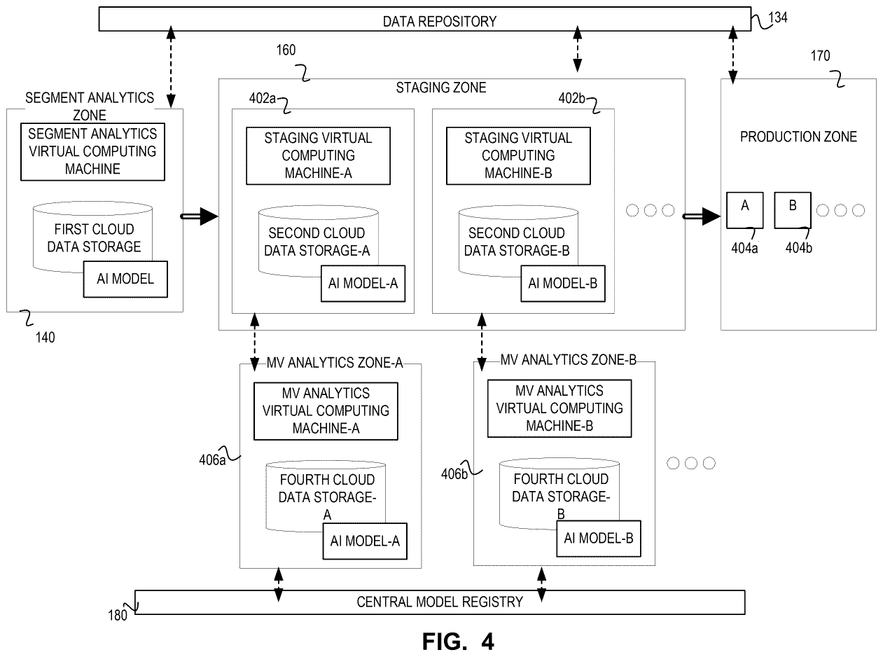

Referring now to FIG. 4, a schematic diagram of parts of a cloud computing cluster system, such as the computing cloud cluster 130, are shown according to least some other embodiments. The configuration of the different zones in FIG. 4 show that different patterns of zones may be used.

In FIG. 4, an AI model trained in the segment analytics zone 140 is deployed and tested in multiple different virtual computing environments 402a, 402b in the staging zone 160, and deployed and operated respectively in multiple different virtual computing environments 404a, 404b in the production zone 170.

For example, the AI model trained in the segment analytics zone 140 is tested in the computing environment 402a and analyzed in the respective MV analytics zone 406a. When a deployment condition is met, the trained AI model from the computing environment 402a in the staging zone 160 is deployed into the computing environment 404a in the production zone 170. In some cases, these computing environments 402a, 404a and the respective MV analytics zone 406a are dedicated to a first application.

Similarly, for example, the AI model trained in the segment analytics zone 140 is tested in the computing environment 402b and analyzed in the respective MV analytics zone 406b. When a deployment condition is met, the trained AI model from the computing environment 402b in the staging zone 160 is deployed into the computing environment 404b in the production zone 170. In some cases, these computing environments 402b, 404b and the respective MV analytics zone 406b are dedicated to a second application, different from the first application. For example, the first application is for a first operation unit associated with a first set of data accounts, and the second application is for a second operation unit associated with a second set of data accounts.

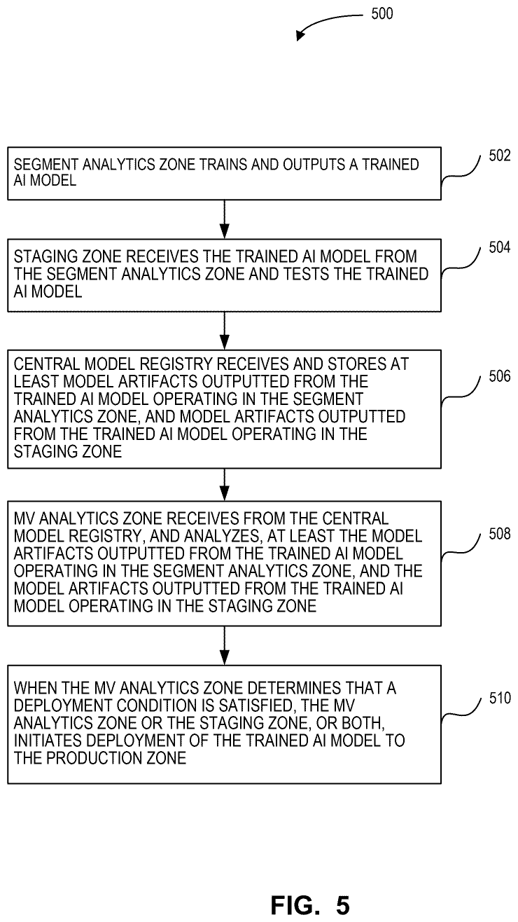

Referring to FIG. 5, a computing process 500 for training and deploying an AI model is provided.

Block 502: The segment analytics zone trains and outputs a trained AI model.

Block 504: The staging zone receives the trained AI model from the segment analytics zone and tests the trained AI model.

Block 506: The central model registry receives and stores at least model artifacts outputted from the trained AI model operating in the segment analytics zone, and model artifacts outputted from the trained AI model operating in the staging zone.

Block 508: The MV analytics zone receives from the central model registry, and analyzes, at least the model artifacts outputted from the trained AI model operating in the segment analytics zone, and the model artifacts outputted from the trained AI model operating in the staging zone.

Block 510: When the MV analytics zone determines that a deployment condition is satisfied, the MV analytics zone or the staging zone, or both, initiates deployment of the trained AI model to the production zone.

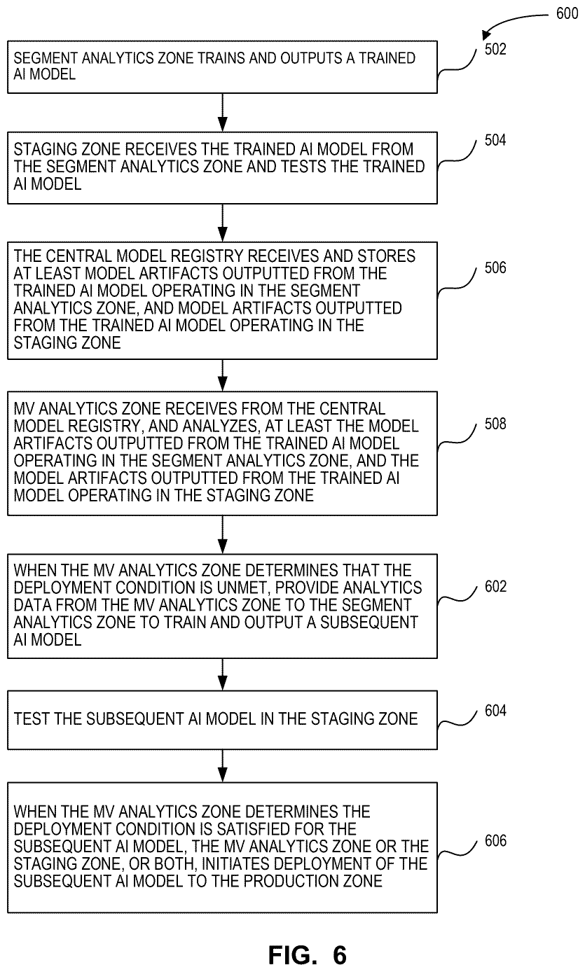

Referring to FIG. 6, a computing process 600 for a ML pipeline with an artifact adapter is provided.

Blocks 502 to 508 are performed.

Block 602: When the MV analytics zone determines that the deployment condition is unmet, the process includes providing analytics data from the MV analytics zone to the segment analytics zone to train and output a subsequent AI model.

Block 604: Test the subsequent AI model in the staging zone.

Block 606: When the MV analytics zone determines the deployment condition is satisfied for the subsequent AI model, the MV analytics zone or the staging zone, or both, initiates deployment of the subsequent AI model to the production zone.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical, or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A cloud computing system comprising:
a segment analytics zone configured to train and output a trained artificial intelligence (AI) model;
a staging zone configured to receive the trained AI model from the segment analytics zone and test the trained AI model;
a central model registry configured to receive and store at least model artifacts outputted from the trained AI model operating in the segment analytics zone, and model artifacts outputted from the trained AI model operating in the staging zone; and
a model validation (MV) analytics zone, the MV analytics zone configured to:
receive from the central model registry, and analyze, at least the model artifacts outputted from the trained AI model operating in the segment analytics zone,
receive the model artifacts outputted from the trained AI model operating in the staging zone, and
when the MV analytics zone determines that a deployment condition is satisfied, the MV analytics zone or the staging zone, or both, initiates deployment of the trained AI model to a production zone.

2. The cloud computing system of claim 1, wherein the staging zone is configured as a computing framework representative of a production framework, and the production zone configured as the production framework; and
wherein, after the trained AI model has been deployed from the staging zone to the production zone, the production zone is configured to automatically operate the trained AI model in the production framework.

3. The cloud computing system of claim 1, wherein the deployment of the trained AI model to the production zone comprises automatically transferring the model artifacts outputted from the trained AI model operating in the staging zone, which are stored in the central model registry, to the trained AI model in the production zone.

4. The cloud computing system of claim 1, wherein the deployment condition comprises the trained AI model in the staging zone generating a set of staging results that are within an expected range as a set of training results generated by the trained AI model in the segment analytics zone.

5. The cloud computing system of claim 1, wherein, when the MV analytics zone determines that the deployment condition is unmet, analytics data from the MV analytics zone is provided to the segment analytics zone to train and output a subsequent AI model; the subsequent AI model is tested in the staging zone; and, when the MV analytics zone determines the deployment condition is satisfied for the subsequent AI model, the MV analytics zone or the staging zone, or both, initiates deployment of the subsequent AI model to the production zone.

6. The cloud computing system of claim 1, further comprising a data repository, which comprises production data and training data, the training data comprising masked data derived from the production data; wherein the trained AI model in the segment analytics zone is trained using the training data obtained from the data repository; and wherein the trained AI model in the staging zone is tested using the production data.

7. The cloud computing system of claim 1, wherein the segment analytics zone comprises a first set of data security conditions; the staging zone comprises a second set of data security conditions that is more restrictive than the first set of data security conditions; and the production zone comprises a third set of data security conditions that is more restrictive than the second set of data security conditions.

8. The cloud computing system of claim 7, wherein the first set of data security conditions comprises a first number of data access accounts permitted to access the segment analytics zone; wherein the second set of data security conditions comprises a second number of data access accounts permitted to access the staging zone, the second number less than the first number; and wherein the third set of data security conditions comprises a third number of data access accounts permitted to access the production zone, the third number less than the second number.

9. The cloud computing system of claim 1, comprising a delivery pipeline that connects at least the segment analytics zone, the staging zone, and the production zone; and, wherein the trained AI model in the segment analytics zone is deployed to the staging zone via the delivery pipeline, and the trained AI model in the staging zone is deployed to the production zone via the delivery pipeline.

10. The cloud computing system of claim 9, comprising a data pipeline that connects the central model registry to the MV analytics zone, wherein the MV analytics zone is configured to only read data from the central model registry via the data pipeline.

11. A method for deploying an artificial intelligence (AI) model, the method executed in a cloud computing system comprising a segment analytics zone, a staging zone, production zone, a central model registry, and a model validation (MV) analytics zone;
the method comprising:
the segment analytics zone training and outputting a trained AI model;
the staging zone receiving the trained AI model from the segment analytics zone and testing the trained AI model;
the central model registry receiving and storing at least model artifacts outputted from the trained AI model operating in the segment analytics zone, and model artifacts outputted from the trained AI model operating in the staging zone;
the MV analytics zone receiving from the central model registry, and analyzing, at least the model artifacts outputted from the trained AI model operating in the segment analytics zone, and the model artifacts outputted from the trained AI model operating in the staging zone; and
when the MV analytics zone determines that a deployment condition is satisfied, the MV analytics zone or the staging zone, or both, initiating deployment of the trained AI model to a production zone.

12. The method of claim 11, wherein the staging zone is configured as a computing framework representative of a production framework, and the production zone is configured as the production framework; and the method further comprising: after the trained AI model has been deployed from the staging zone to the production zone, the production zone automatically operates the trained AI model in the production framework.

13. The method of claim 11, wherein the deployment of the trained AI model to the production zone comprises automatically transferring the model artifacts outputted from the trained AI model operating in the staging zone, which are stored in the central model registry, to the trained AI model in the production zone.

14. The method of claim 11, wherein the deployment condition comprises the trained AI model in the staging zone generating a set of staging results that are within an expected range as a set of training results generated by the trained AI model in the segment analytics zone.

15. The method of claim 11, further comprising: when the MV analytics zone determines that the deployment condition is unmet, analytics data from the MV analytics zone is provided to the segment analytics zone to train and output a subsequent AI model; the subsequent AI model is tested in the staging zone; and, when the MV analytics zone determines the deployment condition is satisfied for the subsequent AI model, the MV analytics zone or the staging zone, or both, initiating deployment of the subsequent AI model to the production zone.

16. The method of claim 11, wherein the cloud computing system further comprises a data repository, which comprises production data and training data, the training data comprising masked data derived from the production data; wherein the trained AI model in the segment analytics zone is trained using the training data obtained from the data repository; and wherein the trained AI model in the staging zone is tested using the production data.

17. The method of claim 11, wherein the segment analytics zone comprises a first set of data security conditions; the staging zone comprises a second set of data security conditions that is more restrictive than the first set of data security conditions; and the production zone comprises a third set of data security conditions that is more restrictive than the second set of data security conditions.

18. The method of claim 17, wherein the first set of data security conditions comprises a first number of data access accounts permitted to access the segment analytics zone; wherein the second set of data security conditions comprises a second number of data access accounts permitted to access the staging zone, the second number less than the first number; and wherein the third set of data security conditions comprises a third number of data access accounts permitted to access the production zone, the third number less than the second number.

19. The method of claim 11, wherein the cloud computing system further comprises:
a delivery pipeline that connects at least the segment analytics zone, the staging zone, and the production zone; and, wherein the trained AI model in the segment analytics zone is deployed to the staging zone via the delivery pipeline, and the trained AI model in the staging zone is deployed to the production zone via the delivery pipeline; and
a data pipeline that connects the central model registry to the MV analytics zone, wherein the MV analytics zone is configured to only read data from the central model registry via the data pipeline.

20. A non-transitory computer readable medium storing computer executable instructions which, when executed by at least one computer processor, cause the at least one computer processor to carry out a method for deploying an artificial intelligence (AI) model, the method comprising:
a segment analytics zone training and outputting a trained AI model;
a staging zone receiving the trained AI model from the segment analytics zone and testing the trained AI model;
a central model registry receiving and storing at least model artifacts outputted from the trained AI model operating in the segment analytics zone, and model artifacts outputted from the trained AI model operating in the staging zone;
a model validation (MV) analytics zone receiving from the central model registry, and analyzing, at least the model artifacts outputted from the trained AI model operating in the segment analytics zone, and the model artifacts outputted from the trained AI model operating in the staging zone; and
when the MV analytics zone determines that a deployment condition is satisfied, the MV analytics zone or the staging zone, or both, initiating deployment of the trained AI model to a production zone.
